(19) United States
(12) Patent Application Publication
(10) Pub. No.: US 2025/0285018 A1
(43) Pub. Date: Sep. 11, 2025

(54) ENCODING AIRCRAFT SEAT ACCELERATION USING FEDERATED LEARNING

(71) Applicant: B/E Aerospace, Inc., Winston-Salem, NC (US)

(72) Inventors: Joseph J. Ensberg, West Hartford, CT (US); Piyush Yadav, Cork (IE); Kimberly Sayre, Bloomfield, CT (US); Jnana Vamsi Kumar Basa, Anaparthi (IN); Supriya Elisa Joseph, Kottayam (IN); Gregory M. Wagner, Tucson, AZ (US)

(21) Appl. No.: 19/048,449

(22) Filed: Feb. 7, 2025

(30) Foreign Application Priority Data
Mar. 8, 2024 (IN) 202411016924

(51) Int. Cl. G06N 20/00; B64D 45/00

(52) U.S. Cl. CPC G06N 20/00; B64D 45/00; B64D 2045/0085

(57) ABSTRACT

A device may include at least one sensor configured to detect a characteristic of a cabin component and generate sensor data. A device may include at least one local processor configured to: receive sensor data, train a local model based on the sensor data, send the local model to a federated server. A device may include an interface device communicatively coupled to the at least one sensor and the at least one processor, the interface device configured to transfer the sensor data from the at least one sensor to one or more of the at least one local processor.

### CROSS-REFERENCE TO RELATED APPLICATION

The present application claims the benefit of Indian Provisional Patent No. 202411016924, filed Mar. 8, 2024, which is incorporated herein by reference in the entirety.

### BACKGROUND

Data gained from passengers or travel equipment (e.g., seats or beds) used by passengers can be analyzed in an effort to both determine problems that arise while traveling and to find solutions for these problems, such as excess seat vibration. However, acquiring these types of data in a laboratory setting is cumbersome and expensive, and the data acquired from the laboratory may not effectively solve the problem at hand.

### SUMMARY

In some aspects, the techniques described herein relate to a system including: at least one sensor configured to detect a characteristic of a cabin component and generate sensor data; at least one local processor configured to: receive sensor data; train a local model based on the sensor data; send the local model to a federated server; and an interface device communicatively coupled to the at least one sensor and the at least one processor, the interface device configured to transfer the sensor data from the at least one sensor to one or more of the at least one local processor.

In some aspects, the techniques described herein relate to a system, further including: the federated server, including at least one federated processor configured to: store a global model; receive the local model; and retrain the global model based on the received local model; and send the global model to the local processor.

In some aspects, the techniques described herein relate to a system, further including: a first network interface device communicatively coupled to the local processor and configured to send the local model to the federated server; and a second network interface device communicatively coupled to the federated server and configured to receive the local model.

In some aspects, the techniques described herein relate to a system, wherein the interface device includes the first network interface device.

In some aspects, the techniques described herein relate to a system, wherein the first network device communicates with the second network device via an MQ Telemetry Transport (MQTT) protocol.

In some aspects, the techniques described herein relate to a system, further including a human-machine interface communicatively coupled to at least one of the interface device or the at least one local processor, the human-machine interface configured to display a visualization of a training and/or prediction of the local model.

In some aspects, the techniques described herein relate to a system, wherein the cabin component includes a passenger seat.

In some aspects, the techniques described herein relate to a system, wherein the characteristic includes vibration.

In some aspects, the techniques described herein relate to a system, wherein the sensor includes at least one of an accelerometer, a gyroscope, a microphone, or an image sensor.

In some aspects, the techniques described herein relate to a system, wherein the sensor includes an accelerometer.

In some aspects, the techniques described herein relate to a system, wherein the sensor includes a camera.

In some aspects, the techniques described herein relate to a system, wherein the sensor includes a gyroscope.

In some aspects, the techniques described herein relate to a system, wherein the cabin component includes an aircraft cabin component.

In some aspects, the techniques described herein relate to a system including: a passenger seat; an accelerometer configured to detect a vibration of the passenger seat and generate sensor data; at least one local processor configured to: receive the sensor data from the accelerometer; train a local model based on the sensor data; and send the local model to a federated server; an aircraft interface device communicatively coupled to an accelerometer and the at least one processor, the aircraft interface device configured to transfer the sensor data from the at least one sensor to one or more of the at least one processor; and the federated server, including: at least one federated processor configured to: store a global model; receive the local model; and retrain the global model based on the received local model; and send the global model to the local processor.

In some aspects, the techniques described herein relate to a system, further including a human-machine interface communicatively coupled to at least one of the aircraft interface device or the at least one local processor, the human-machine interface configured to display a visualization of a training of the local model or a prediction of the local model.

In some aspects, the techniques described herein relate to a method including: receiving sensor data from an aircraft cabin component; training a local model based on the sensor data; sending/transmitting the local model to a federated server, wherein the federated server stores a global model; updating the global model based on the received local model; and sending the global model to the local processor.

In some aspects, the techniques described herein relate to a method, wherein the sensor data includes at least one of accelerometer data, gyroscope data, image data, or microphone data.

In some aspects, the techniques described herein relate to a method, wherein the sensor data includes image data and accelerometer data.

In some aspects, the techniques described herein relate to a method, further including fusing the image data with the accelerometer data.

In some aspects, the techniques described herein relate to a method, wherein the aircraft cabin component includes a passenger seat.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a block diagram of a system for updating a global model, in accordance with one or more embodiments of the disclosure.

FIG. 2A illustrates a method for updating a global model via federated learning, in accordance with one or more embodiments of the disclosure.

FIG. 2B illustrates a method for updating a fleet model via federated learning, in accordance with one or more embodiments of the disclosure.

FIG. 3 illustrates a block diagram detailing the functions of an edge device and a federated server, and the interaction between the edge device and the federated server, in accordance with one or more embodiments of the disclosure.

FIG. 4 illustrates a use of federated learning for analyzing vibration signatures in a passenger seat, in accordance with one or more embodiments of the disclosure.

FIG. 5 illustrates a flow diagram of a method for federated learning, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Broadly, embodiments of the concepts disclosed herein may be directed to a system and method including a federated learning system for encoding data from passengers or passenger equipment such as passenger seats of a vehicle into a collection of neural networks. The system and method use sensors to collect data from passengers or passenger equipment and train a local model within the vehicle that characterizes a function of the passenger equipment. The local model is then transferred to a federated server that is updating a global model for the function of the passenger equipment. The local model then updates the global model. The updated global model may then be transferred back to the vehicle, where the updated global model then replaces the local model. This iterative approach to updating the global model provides a pathway toward optimizing vehicle interiors for safety and comfort. The approach also provides data security to each vehicle, as the data received from each vehicle remains separate from the federated server.

As used herein, and for the sake of clarity, the term “training” is meant to describe the process by which a local model (e.g., a lower-level model in a hierarchy of models) is changed or improved upon, whereas the term “updating” is meant to describe the process by which a global model (e.g., a higher-level model in a hierarchy of models) is changed or improved. For example, and as used herein, a local model may be trained, and a global model may be updated. In some instances, the local model can be replaced with a global model. In another example, a fleet model (e.g., a higher-level model than a global model) may be updated, with the global model being either trained or updated. Because the terms “training” and “updating” have overlapping definitions, it is therefore possible that local models, global models, fleet models may be either “updated” or “trained”.

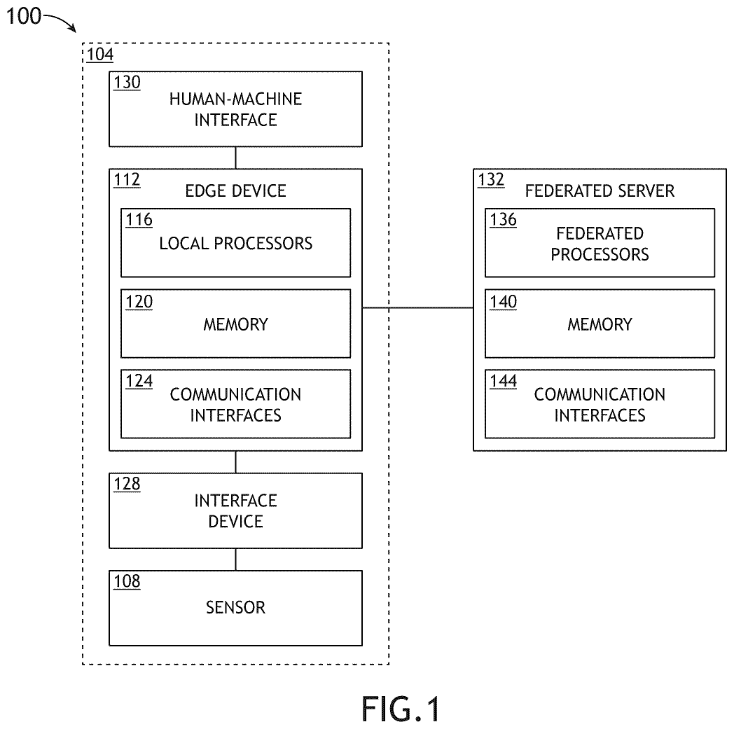

Referring to FIG. 1-5, embodiments of a system 100 according to the concepts disclosed here are depicted. In embodiments, the system 100 may be implemented into any suitable system, such as at least one vehicle (e.g., an aircraft, a spacecraft, an automobile, a watercraft, a submarine, or a train). For example, the system may include or be partially or wholly integrated within an aircraft 104. The system 100 may include or more sensors 108 configured to detect a characteristic, such as vibration, of a component of the vehicle (e.g., a passenger seat). The system includes an edge device 112, a local processing device that is communicatively coupled to the one or more sensors 108. The edge device 112 includes one or more local processors (e.g., local processors 116), memory 120, and a communication interface 124. The system further includes an interface device 128, such as an aircraft interface device (AID) that enables communication between the sensor 108 and the edge device 112. The system 100 may further include a human-machine interface (HMI) 130, such as a computer, laptop, monitor, or display.

In embodiments, the HMI visualizes neural network training results, or a prediction of the training results, as they proceed within the system 100. The HMI 130 may also visualize the real-time health of the vehicle, vehicle component (e.g., passenger seat), or other entity that is employing the system 100. Examples of results/data reported by the HMI 130 include classifications of the vibration signatures as interpreted by the one or more local processors 116 (via a neural network prediction model). For instance, for a passenger sitting in a passenger seat monitored for vibration, the neural network prediction model may classify a vibration signature as a normal vibration (e.g., normal for a passenger sitting in a passenger seat), which is reported on the HMI 130. In another instance, the neural network prediction model may classify a vibration signature as a “jerk” movement by the passenger (e.g., possibly indicating that the passenger is uncomfortable), which would also be reported on the HMI 130.

In embodiments, the models used within the system 100 can perform either classification or prediction tasks based on use cases. For example, the models may provide class labels (e.g., “jerk” or “no jerk”) described as, or provided as, discrete values. In another example, the models may provide prediction tasks that include providing categorical values to the data (e.g., such as a value on how accurately the model predicts incoming/new data).

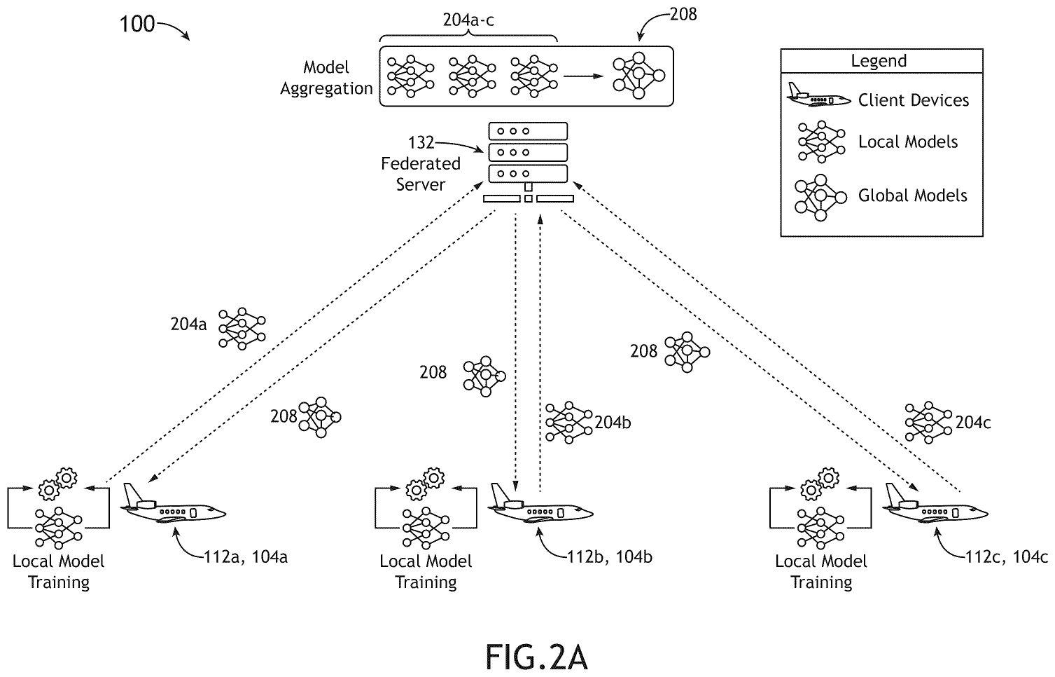

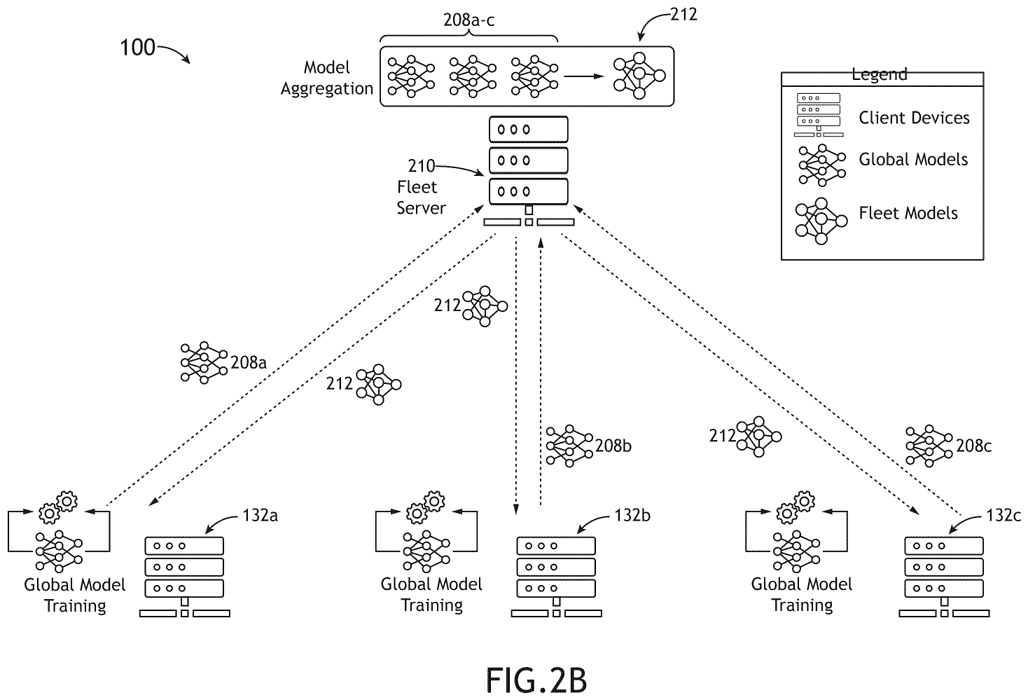

In embodiments, the one or more local processors 116 of the edge device 112 receive sensor data, train a local model (e.g., a neural network model) based on the sensor data, and send the local model to the federated server 132, as shown in FIG. 2A. The system 100 may include more than one aircraft 104a-c, each containing an edge device 112a-c that can train a local model 204a-c and send the local model to the federated server 132. Upon initiation of the system 100, the federated server 132 stores a generic baseline global model 208 that is shared with the edge devices 112a-c. The edge devices 112a-c then train the models based on local data, such as data received from the sensors 108, producing local models 204a-c. The local models 204a-c are then shared with the federated server 132, which updates the global model 208. Updating the global model 208 uses various aggregation techniques that combine sensor data trained on sensor data local to the vehicle. For example, updating may include combining/aggregating local models trained on sensor data. The process is an iterative process resulting in greater accuracy over time.

In embodiments, the system 100 further includes a federated server 132 communicatively coupled to the edge device 112 (e.g., via the interface device 128 or a network interface), as shown in FIG. 2A. The federated server includes one or more processors (e.g., a federated processor 136, memory 140, and a communication interface 144. The federated server 132 may be located either on-board, or outside of, the aircraft 104 or vehicle of the system 100. For example, the federated server 132 may be located on-wing of an aircraft 104. For instance, the system 100 may include several sensors 108 located on several components (e.g., passenger seats) of the aircraft 104, with data from the several sensors 108 being trained on one or more edge devices 112. The local models trained by one or more edge devices 112 would then be sent to the on-wing federated server 132 in order to update the global model.

In embodiments, the system 100 may include more than two model training levels (e.g., other than local model training and global model updating). For example, the system 100 may include a fleet server 210, a higher-level federated server capable of receiving global models 208a-c from one or more federated servers 132a-c (located on-wing or off-wing), as shown in FIG. 2B. Similar to the action of the federated servers 132a-c with the one or more edge devices 112a-c, the fleet server 210 may aggregate one or more global models 208a-c to generate a fleet model 212 that is then transmitted back to the federated server 132a-c (or edge device 112a-c). the federated server 132a-c may then transmit the fleet model 212 to the one or more edge devices 112a-c), as in FIG. 2A. In this matter, the local model for each passenger seat of a fleet of aircraft could be updated based on a fleet model 212.

### In

In embodiments, data transmitted from the edge device 112 to the federated server 132 includes no vehicle-identifiable information (e.g., information regarding the identification or description of the vehicle (e.g., aircraft 104). For example, the local model 204 may send local model data configured as neural network weight to the federated server 132. The neural network weights do not include identifying information. Therefore, if local model data transmitted from the edge device were to be intercepted by an agent, the agent would not gain any useful information about the aircraft 104, information about components of the aircraft 104, or information about passengers of the aircraft.

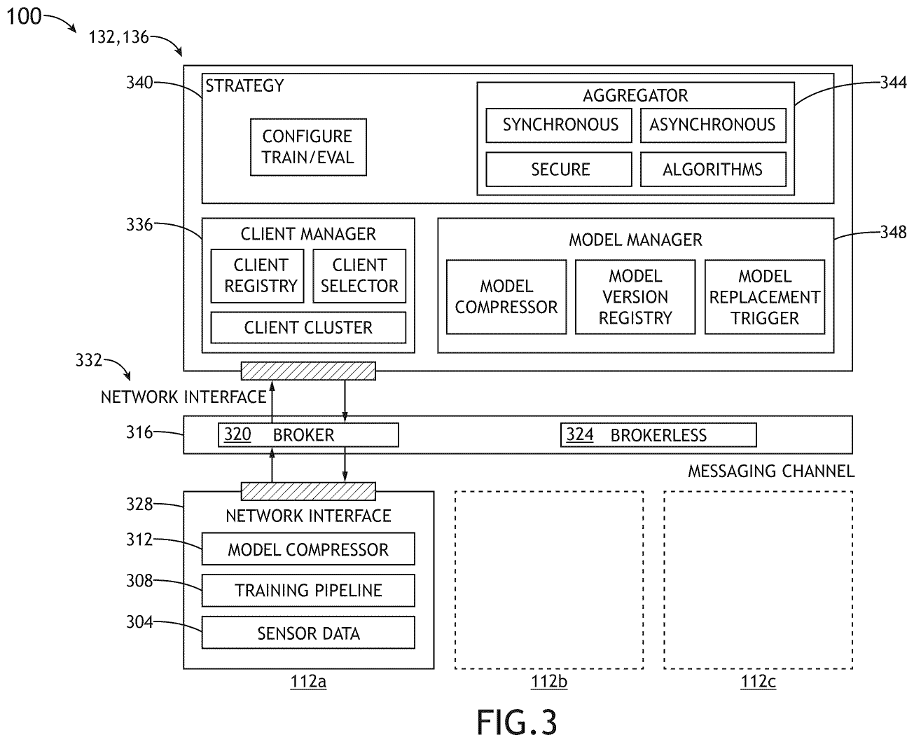

Details of the interaction between the edge devices 112a-c and the federated server 132 are shown in FIG. 3. The edge devices 112a-c receive and store sensor data 304. The sensor data 304 is trained via a training pipeline 308. The training may include one or more types of artificial intelligence training, machine learning training, and neural network training. For example, the training pipeline 308 may include neural network training via one or more neural network training algorithms including but not limited to backpropagation (e.g., a gradient estimation method), Hebbian Learning Rule, Self-Organizing Kohonen Rule, Hopfield Network Law, Least Mean Square algorithm, or Competitive learning. The neural networks may be of any type including but not limited to Feed Forward, Recurrent, Single-layer, Multi-layer, Fixed, Adaptive, Static, or Dynamic. The neural network may include any type of network architecture including but not limited to a Perceptron Model, Radial Basis Function Neural Network, a Multilayer Perceptron Neural Network, a Recurrent Neural Network, a Long Short-Term Memory Neural Network (LSTM), a Hopfield Network, a Boltzmann Machine Neural Network, a Convolutional Neural Network, a Modular Neural Network, and Physical Neural Network. The learning techniques used in the neural network may include but not be limited to supervised learning, unsupervised learning, offline learning (e.g., where the model is trained at the end of a flight), and online learning (e.g., wherein the model is trained continuously throughout the flight). The neural network formed by the training may comprise a classification neural network, a prediction neural network, a clustering neural network, or an association neural network. As described herein, data used for training (e.g., such as offline training or offline training) remains local (e.g., does not leave the edge device 112 or vehicle and is not received by the federated server 132).

In embodiments, the one or more local processors 116 may perform model compression (e.g., via instructions in memory 120 coding for a model compressor 312). The model compressor 312 reduces the size of the neural network while preventing overt compromise on the accuracy of the neural network. The model compressor 312 may utilize one or more compression techniques including but not limited to pruning, quantization, knowledge distillation, and low-rank factorization.

In embodiments, the local model 204 is transferred from the edge device to the federated server 132 via a messaging channel 316 using broker 320 or brokerless 324 communication protocols. The communication protocols may utilize various methods including, but not limited to, remote procedure calls (RPC) (e.g., Google RPC (gRPC)), queuing system methods (e.g., ActiveMQ, RabbitMQ, Kafka), and brokerless-like methods (e.g., ZeroMQ). For example, the local model 204 may communicate with the federated server 132 via a method including, but not limited to, an MQ Telemetry Transport (MQTT) protocol (e.g., an MQTT broker). In embodiments, the edge device 112a-c and the federated server 132 may communicate via the messaging channel 316 through a first network interface device 328, and a second network interface device 332, respectively.

In embodiments, the one or more federated processors 136 stores and/or trains an initial global model 208. For example, the federated processors 136 may store or train a global model 208 based on previously received sensor data 304. The one or more federated processors 136 may also receive one or more local models 204 and retrain/update the global model 208 based on the data received from the local model 204. The one or more federated processors 136 may then send the now retrained/updated global model back to the one or more edge devices 112. The functions taken by the federated server 132 are accomplished by various programs and executed by one or more federated processors 136.

The global model 208 may be initiated by one of several methods. For example, one approach to initiating a global model 208 may include, but not be limited to, initializing within the federated server 132 a global model 208 with random weights that are transmitted to the edge device 112. The edge device 112 then trains the local model 204 based on the global model 208, which are then transmitted back to the federated server 132 and aggregated to update the global model 208 (e.g., as part of an iterative process). In another approach to initiating a global model 208, a global model 208 is initially trained on previously received sensor data. The global model 208 can then be updated when a new local model 204 is available.

In embodiments, the one or more federated processors 136 executes a client manager 336, a program (e.g., or suite of programs) that keeps track of the operation of the edge devices 112 communicatively coupled to the federated server, as shown in FIG. 3. The client manager 336 may include a client registry program that controls registration and activation of the edge devices 112 and their activities. The client manager 336 may include a client selector program that selects which edge device 112 receives a specific federated updating task. The client manager 336 may also include a client clustering program that organizes clusters of edge devices 112 to share information, which may increase a privacy aspect of the data transmitted between the federated server 132 and the edge devices 112, potentially preventing the federated server from determining which specific sets of data come from which edge device 112, resulting in increased data privacy.

In embodiments, the one or more federated processors 136 executes a strategy module 340, a program (e.g., or suite of programs) that configures aspects of the training and evaluation protocols used for the updating of the global model 208. The one or more federated processors 136 may also execute an aggregator program 344 (e.g., or suite or programs) that combine the uploaded local models 204 with the global model 208, effectively updating the global model 208. The aggregator program 344 may execute a synchronous aggregation protocol wherein the federated server updates/trains the global model 208 after all edge devices 112 have sent their local model 204. The aggregator program may also execute an asynchronous aggregation protocol wherein the federated server receives the local model 204 from edge devices 112 asynchronously, and updates/trains the global model 208 when upon receiving local models 204 asynchronously from the edge devices 112. The aggregator program 344 may further include algorithms for performing the aggregator and updating tasks. In embodiments, the aggregation process is secure in that the federated server learns only of the updating (e.g., aggregated model update) and does not receive data that may be identified with a specific edge device 112.

In embodiments, the one or more federated processors 136 executes a model manager 348, a program (e.g., or suite of programs) that enables the federated server 132 to send the updated/trained global model 208 to the edge devices 112. The model manager 348 may include a model version registry, a model compressor that compresses the global model 208 before the global model is sent to the edge devices 112, and a model replacement trigger program that determines a proper time to send the updated global model to the edge devices 112.

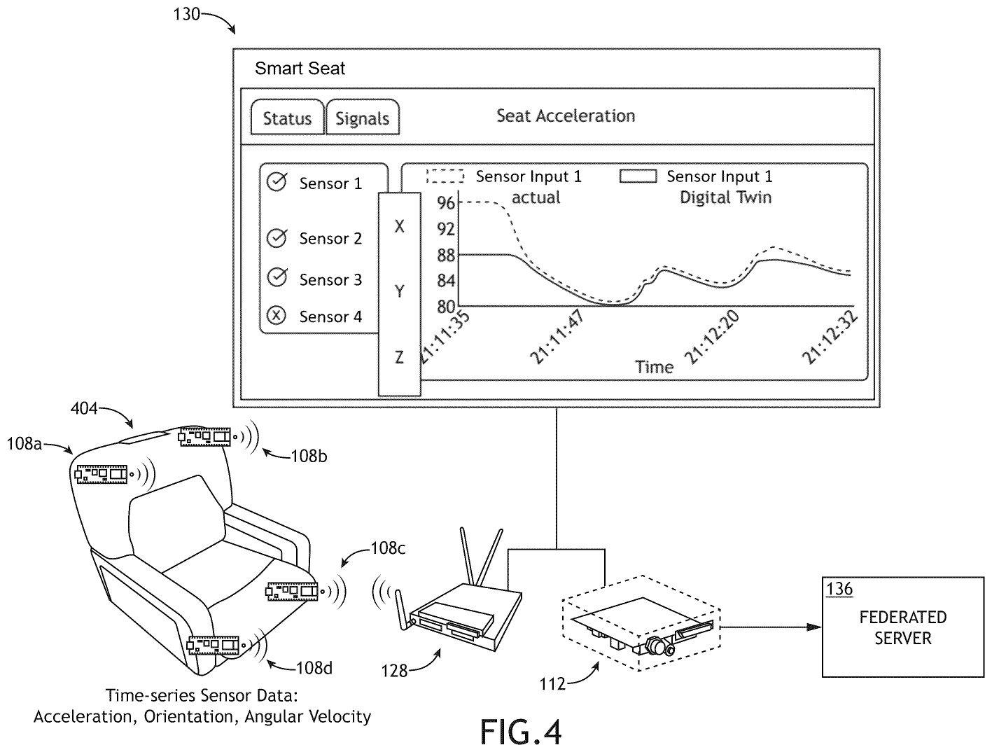

An environment for using the system 100 is shown in FIG. 4. Here, a passenger seat 404 is outfitted with a set of sensors 108a-d (e.g., accelerometers) that send out data signals. The data signals are received by an interface device (e.g., an aircraft interface device), which transmits the data to the edge device 112. The edge device 112 can then perform training of the local model 204 based on the received sensor data, and then send the local model 204 to the federated server 132. The system 100 may include a local HMI 130 (e.g., a tablet or laptop) that visualizes the training process and possibly other processes of the system 100, such as sensor data, local model transmit data, and prediction results/values from the model, as well as sensor data and performance date from hardware/componentry (e.g., memory use and CPU consumption). The edge device may include any type of processing device capable of performing model training.

The cabin component interrogated by the system 100 may include any cabin component including but not limited to a passenger seat, a passenger bed, a window, a window shade, an entertainment system, a floor, a toilet, or a sink. The characteristics of the cabin component measured by the system may include but not be limited to vibration, temperature, movement, humidity, air pressure, and noise levels. Sensors 108 included in the system 100 may include but not be limited to accelerometers, cameras (e.g., image sensors), thermometers, hygrometers, gyroscopes, barometers, microphones, and decibel meters. The system 100 may incorporate more than one type of sensor. For example, the system may incorporate both accelerometers and cameras. For instance, the system 100 may use accelerometers to measure vibration (e.g., or a passenger seat), and cameras (e.g., image processors) that can determine if a passenger is in the seat and/or performing a specific activity in the seat (e.g., eating). In this manner, the camera can inform the model of the context by which the accelerometer is measuring vibration. In some embodiments, the system 100 is configured, via one or more local processors 116, to fuse image data (e.g., from cameras) with the accelerometer date.

In one example of the system 100, a vibration of a passenger seat 404 of an aircraft 104 is investigated (e.g., as illustrated in FIG. 4). Accelerometers are integrated into the passenger seat 404, and vibration signatures of the passenger seat are sensed by the accelerometers, and the resulting sensor data is sent to the edge device 112 for training the local model 204. The system may generate vibration signatures based on aircraft operation data (e.g., flight phase vs. time), and/or passenger activity (e.g., sitting, reclining, or sleeping vs. time). The system may also generate vibration signatures based on the seat model. The hardware and software of the system encode the passenger seat vibration signatures in a collection of neural networks using the federated machine learning architecture as described herein. The sensor data 304 may be transmitted to the interface device 128 wirelessly. The neural network training of the local model may take continuously or near-continuously within the vehicle. Once the local model 204 has been trained, the local model 204 is transmitted to the federated server 132. Within the federated server 132, the global model is monitored and may be retrained (e.g., for each aircraft), and then reaggregated and updated again, repeating the cycle. The sensor data 304 (e.g., vibration data) used for training the local model 204, and updating the global model 208 remains within the vehicle, as described herein.

In the example above, the vibration signatures, now encoded as neural networks and trained models, can be used to optimize (e.g., hyper-optimize) cabin components which may result in an improved passenger experience. Because the raw sensor data 304 is kept from the federated server 132, the airline privacy concerns that may otherwise prevent open sharing or raw data. The use of MQTT messaging protocols, model compressors, and other time-saving aspects of the system may reduce bandwidth concerns of aircraft operators.

In embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using MQTT message protocols and/or according to other communication protocols. Microservices may be managed and updated separately, written in different languages (e.g., but may be written exclusively or near-exclusively in Python), and be executed independently from other microservices. In embodiments, one or more microservices are deployed as a docker container. In embodiments, sensors 108, such as accelerometers, are flashed with code written and compiled in C.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

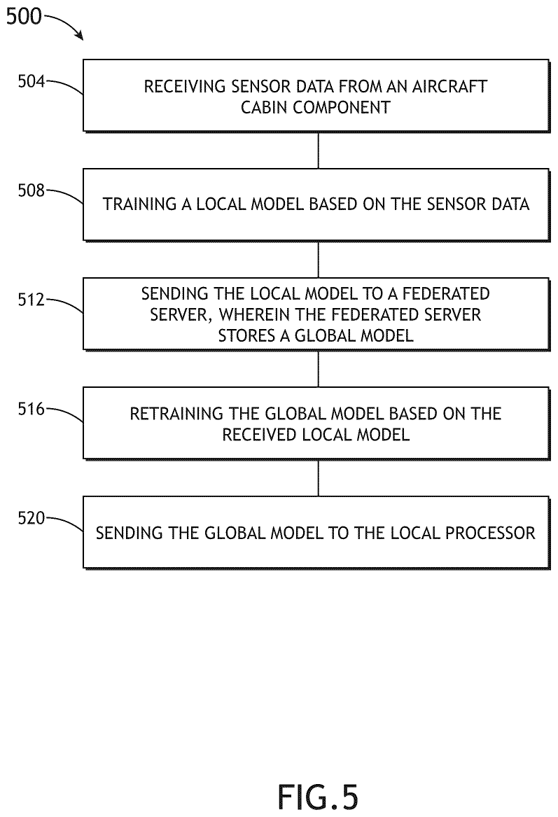

In embodiments, a method 500 for updating a global model 208 is disclosed, as shown in FIG. 5. The method 500 utilizes the system 100 described herein. In embodiments, the method 500 includes a step 604 of receiving sensor data 304 from an aircraft cabin component. For example, one of the one or more local processors 116 may receive sensor data 304 from one or more sensors 108 (e.g., accelerometers) coupled to, or integrated with, a passenger seat 404.

In embodiments, the method 500 includes a step 508 of training a local model 204 based on the sensor data 304. The training may be based on one or more training methods and protocols as described herein.

In embodiments, the method 500 includes a step 512 of sending the local model 204 to a federated server 132, wherein the federated server 132 stores a global model 208. For example, the edge device 112 may send the local model 204 to the federated server 132 via the messaging channel 316.

In embodiments, the method 500 includes a step 516 of updating the global model 208 based on the received local model 204. Updating the global model 208 may include updating the global model 208 based on the local model 204. The global model may be updated using one or more of the training and aggregation methods and protocols as described herein.

In embodiments, the method includes a step 520 of sending the global model 208 to the local processor 116. For example, the federated server 132 may send the now updated global model 208 to the edge device 112 via the messaging channel 315 (e.g., via an MQTT protocol).

In embodiments, the system 100 includes the sensor 108, the edge device 112 (e.g. containing the one or more local processors 116), and an interface device 128 (e.g., such as an Aircraft Interface Device (AID) manufactured by Collins Aerospace. The system 100 may include the federated server. The system 100 may include the cabin component (e.g., passenger seat 404).

As used throughout and as would be appreciated by those skilled in the art, the at least one local processor 116 and the at least one federated processor 136 may be implemented as any suitable processor(s), such as at least one general purpose processor, at least one central processing unit (CPU), at least one FPGA, at least one image processor, at least one graphics processing unit (GPU), and/or at least one special purpose processor configured to execute instructions for performing (e.g., collectively performing if more than one processor) any or all of the operations disclosed throughout.

As used throughout and as would be appreciated by those skilled in the art, “at least one non-transitory computer-readable medium” or “memory” may refer to as at least one non-transitory computer-readable medium (e.g., e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof).

As used throughout and as would be appreciated by those skilled in the art, the communication interface 124 is configured to facilitate data transfer data between components of the edge device 112, the federated server 132 and/or other componentry within the system 100. The communication interface 124 can be operatively configured to communicate with componentry within the system. For example, the communication interface 124 may be configured to retrieve data from the one or more local processors 116 and/or the one or more federated processors 136, transmit data for storage in the memory 129, retrieve data from storage in the memory 120 and so forth. The communication interface 124 can also be communicatively coupled with the system 100 to facilitate data transfer between components of the system 100.

It should be noted that while the communication interface 124 is described as a component of the one or more local processors 116 and the one or more federated processors 136, one or more components of the communication interface 124 may be implemented as external components communicatively coupled to other components of the system via a wired and/or wireless connection.

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based on design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A system comprising:
at least one sensor configured to detect a characteristic of a cabin component and generate sensor data;
at least one local processor configured to:
receive sensor data;
train a local model based on the sensor data;
send the local model to a federated server; and
an interface device communicatively coupled to the at least one sensor and the at least one local processor, the interface device configured to transfer the sensor data from the at least one sensor to one or more of the at least one local processor.

2. The system of claim 1, further comprising:
the federated server, comprising at least one federated processor configured to:
store a global model;
receive the local model; and
update the global model based on the received local model; and
send the global model to the at least one local processor.

3. The system of claim 2, further comprising:
a first network interface device communicatively coupled to the at least one local processor and configured to send the local model to the federated server; and
a second network interface device communicatively coupled to the federated server and configured to receive the local model.

4. The system of claim 3, wherein the interface device comprises the first network interface device.

5. The system of claim 3, wherein the first network interface device communicates with the second network interface device via an MQ Telemetry Transport (MQTT) protocol.

6. The system of claim 1, further including a human-machine interface communicatively coupled to at least one of the interface device or the at least one local processor, the human-machine interface configured to display a visualization of a training of the local model.

7. The system of claim 1, wherein the cabin component comprises a passenger seat.

8. The system of claim 1, wherein the characteristic comprises vibration.

9. The system of claim 1, wherein the at least one sensor comprises at least one of an accelerometer, a gyroscope, a microphone, or an image sensor.

10. The system of claim 1, wherein the least one sensor comprises an accelerometer.

11. The system of claim 1, wherein the least one sensor comprises a camera.

12. The system of claim 1, wherein the least one sensor comprises a gyroscope.

13. The system of claim 1, wherein the cabin component comprises an aircraft cabin component.

14. A system comprising:
a passenger seat;
an accelerometer configured to detect a vibration of the passenger seat and generate sensor data;
at least one local processor configured to:
receive the sensor data from the accelerometer;
train a local model based on the sensor data; and
send the local model to a federated server;
an aircraft interface device communicatively coupled to the accelerometer and the at least one local processor, the aircraft interface device configured to transfer the sensor data from the at least one local sensor to one or more of the at least one local processor; and
the federated server, comprising: at least one federated processor configured to:
store a global model;
receive the local model; and
update the global model based on the received local model; and
send the global model to the local processor.

15. The system of claim 14, further including a human-machine interface communicatively coupled to at least one of the aircraft interface device or the at least one local processor, the human-machine interface configured to display a visualization of a training of the local model or a prediction of the local model.

16. A method comprising:
receiving sensor data from an aircraft cabin component;
training a local model based on the sensor data;
sending the local model to a federated server, wherein the federated server stores a global model;
updating the global model based on the received local model; and
sending the updated global model to a local processor.

17. The method of claim 16, wherein the sensor data comprises at least one of accelerometer data, gyroscope data, image data, or microphone data.

18. The method of claim 16, wherein the sensor data comprises image data and accelerometer data.

19. The method of claim 18, further comprising fusing the image data with the accelerometer data.

20. The method of claim 16, wherein the aircraft cabin component comprises a passenger seat.
